(19) United States
(12) Patent Application Publication
(10) Pub. No.: US 2025/0316930 A1
(43) Pub. Date: Oct. 9, 2025

(54) SHIELD CONNECTOR

(71) Applicant: J.S.T. Mfg. Co., Ltd., Tokyo (JP)

(72) Inventors: Koji WADA, Miyoshi-shi (JP); Kazumasa OI, Miyoshi-shi (JP)

(73) Assignee: J.S.T. Mfg. Co., Ltd., Tokyo (JP)

(21) Appl. No.: 19/098,828

(22) Filed: Apr. 2, 2025

(30) Foreign Application Priority Data
Apr. 3, 2024 (JP) 2024-060413
Mar. 7, 2025 (JP) 2025-036318

(51) Int. Cl. H01R 13/6581; H01R 13/05; H01R 13/502; H01R 13/6591; H01R 103/00

(52) U.S. Cl. CPC H01R 13/6581; H01R 13/052; H01R 13/502; H01R 13/65912; H01R 2103/00

(57) ABSTRACT

The present invention provides a shield connector usable in a high frequency band. A connector 10 includes a pair of terminals 1, 1 each connected to a corresponding core Wc, an inner housing 2 holding the pair of terminals 1, 1 therein, a metal shell 3 that covers an exposed part of a pair of electric wires W, W to be in close contact with the exposed part, and a cover shell 4 connected to the metal shell 3 in series. An inner cavity of a terminal hole portion 32 into which part of the electric wires W, W exposed by an insulation coating enters is divided to form terminal holes 32h, 32h that are thinner than a crimp portion 31 and partially connected to each other at an outer edge to be shaped like an “infinity symbol”, allowing an insulation coating Wi on the electric wires W to be in close contact with the inner wall of the terminal holes 32h. This achieves excellent signal transmission in a high frequency band.

This application is based on and claims the benefit of priority from Japanese Patent Application Nos. 2024-060413 and 2025-036318, respectively filed on 3 Apr. 2024 and 7 Mar. 2025, the contents of which are incorporated herein by reference.

### BACKGROUND OF THE INVENTION

### Field of the Invention

The present invention relates to a shield connector. The invention particularly relates to a structure of a shield connector that can be attached to an end of a shielded differential cable including a pair of electric wires each having an insulation-coated core, a braided wire covering the electric wires, and an insulation sheath covering the braided wire.

### Related Art

A shielded differential cable such as a shielded twisted quad (STQ) cable or a shielded twisted pair (STP) cable covers two pairs of electric wires with a braided wire to protect electric signals transmitted over core wires from unwanted electromagnetic waves.

For a wire harness transmitting electric signals to electronic devices mounted on an automobile, a shield connector attached to an end of a shielded differential cable (will be hereinafter referred to as a shielded cable) is often used because it is less susceptible to noise and capable of transmitting high frequency signals.

A shield connector that is attached to an end of a STP cable and shows a sufficiently high shielding effect has been known (see, e.g., Patent Document 1).

Patent Document 1: Japanese Unexamined Patent Application, Publication No. 2020-98719

### SUMMARY OF THE INVENTION

Patent Document 1 discloses a shield connector attached to an end of a shielded cable including at least one electric wire with an insulation coating covering the outer periphery of a core and an insulation sheath arranged on the outer periphery of a braided wire surrounding the outer periphery of the electric wire. The shield connector includes: a terminal connected to the core exposed by removing the insulation coating and the braided wire from the end of the shielded cable; an insulative inner housing holding the terminal; a conductive wire shield member covering the exposed part of the electric wire; and a conductive quadrangular prism-shaped shell member covering the inner housing and the wire shield member. The wire shield member is electrically connected to the shell member via two or more shell member contacts away from each other in an extending direction of the exposed part of the electric wire. The two or more shell member contacts include at least one front contact arranged near the terminal and at least one rear contact arranged closer to the insulation coating of the shielded cable than the front contact. The wire shield member includes a cylindrical portion surrounding the outer periphery of the exposed part of the electric wire and a positioning portion that is connected to a front end of the cylindrical portion and caught on a rear end of the inner housing to position the wire shield member relative to the inner housing.

The shield connector of Patent Document 1 includes the terminal connected to the core exposed by removing the insulation coating and the braided wire from the end of the shielded cable, the insulative inner housing holding the terminal, the conductive wire shield member covering the exposed part of the electric wire, and the conductive shell member covering the inner housing and the wire shield member. The wire shield member is electrically connected to the shell member via the two or more shell member contacts spaced apart from each other in the extending direction of the exposed part of the electric wire. This configuration is considered to allow the shield connector to exhibit a sufficient shield effect when attached to the end of the shielded cable.

However, in the shield connector of Patent Document 1, the quadrangular prism-shaped shell member covers the part of the electric wire exposed by removing the braided wire with space (an air layer) left between the insulation coating of the electric wire and the shell member. This may reduce the resistance to noise when the shield connector is used in a high frequency band.

Under these circumstances, a shield connector that is attachable to an end of a shielded cable having a pair of electric wires and a braided wire surrounding the pair of electric wires, usable in a high frequency band, and can reduce impedance is required. This can be the issue of the present invention.

To address this issue, the present invention provides a shield connector that is attachable to an end of a shielded cable having a pair of electric wires and a braided wire surrounding the pair of electric wires, usable in a high frequency band, and can reduce impedance.

The inventors of the present invention provided a metal shell with a terminal hole portion, formed a pair of terminal holes partially connected to each other at an outer edge in the terminal hole portion, and provided an inner housing with a wedge piece protruding from an end of the inner housing to separate the ends of a pair of electric wires at a predetermined pitch. Based on a thought that this configuration would reduce space (an air layer) between an insulation coating on the electric wires and the metal shell, reduce impedance, and allow excellent signal transmission in a high frequency band, the inventors achieved a novel shield connector described below.

A first aspect of the present invention is directed to a shield connector attachable to an end of a shielded differential cable including a pair of electric wires each having an insulation-coated core, a braided wire covering the electric wires, and an insulation sheath covering the braided wire. The shield connector includes: a pair of terminals each connected to a corresponding one of the cores; an inner housing holding the pair of terminals therein; an elliptic tube-shaped metal shell that is electrically connected to the braided wire and covers an exposed part of the pair of electric wires ranging from an end of the braided wire to the terminals to be in close contact with the exposed part; and an elliptic tube-shaped cover shell that is connected to the metal shell in series and covers the inner housing and a front part of the metal shell. The metal shell includes a crimp portion that is crimped to the braided wire from an outer periphery, a terminal hole portion through which the exposed part of the electric wires passes; and a connecting portion that covers the inner housing from an outer periphery. The terminal hole portion includes a pair of terminal holes that are thinner than the crimp portion and partially connected to each other at an outer edge, and the inner housing has a wedge piece that protrudes from an end of the inner housing and separates ends of the pair of electric wires at a predetermined pitch.

According to a second aspect, in the shield connector of the first aspect, each terminal includes a wire connector formed at one end and having a conductor barrel connected to the core by crimping and a terminal connector formed at the other end and having a pair of clipping pieces connectable to a counterpart connector.

According to a third aspect, the shield connector of the first or second aspect further includes an outer housing holding therein the metal shell connected to the shielded differential cable.

According to a fourth aspect, in the shield connector of the third aspect, the outer housing includes a second positioning member that is inserted into the outer housing from below toward the terminal hole portion and restricts an axial movement of the metal shell relative to the outer housing.

In the shield connector of the present invention, the terminal holes into which parts of the electric wires exposed by the insulation coating enter are formed thinner than the crimp portion and shaped like an “infinity symbol”, allowing the parts of the electric wires exposed from the insulation coating to be in close contact with the inner wall of the metal shell. This reduces impedance and allows excellent signal transmission in a high frequency band.

The shield connector of the present invention allows easy insertion of the electric wires with the terminals at the tip end into the terminal holes, and the inner housing has the wedge piece protruding from the end of the inner housing. Thus, the ends of the pair of electric wires in close contact can be separated from each other at a predetermined pitch.

### BRIEF DESCRIPTION OF THE DRAWINGS

FIG. 1 is a front perspective view illustrating the configuration of a shield connector according to an embodiment of the present invention;

FIG. 2 is a rear perspective view illustrating the configuration of the shield connector according to the embodiment;

FIG. 3 is a right-side view illustrating the configuration of the shield connector according to the embodiment;

FIG. 4 is a vertical cross-sectional view illustrating the configuration of the shield connector according to the embodiment taken along the line A-A shown in FIG. 3;

FIG. 5 is an exploded perspective view illustrating the configuration of the shield connector according to the embodiment, showing a terminal assembly before being assembled into an outer housing;

FIG. 6A is an exploded perspective view illustrating the configuration of the shield connector according to the embodiment, showing a first positioning member and a second positioning member before being assembled into the outer housing on the left side of the view and internal components of the shield connector on the right side of the view;

FIG. 6B is an exploded perspective view illustrating the configuration of the shield connector according to the embodiment, showing the members shown on the left side of FIG. 6A assembled together and the components shown on the right side of FIG. 6A assembled together;

FIG. 7 is an exploded perspective view illustrating the configuration of the shield connector according to the embodiment, showing a terminated shielded differential cable before being assembled into a metal shell;

FIG. 8A is a cross-sectional view illustrating the configuration of the shield connector according to the embodiment taken along the line B-B shown in FIG. 4;

FIG. 8B is a cross-sectional view illustrating the configuration of the shield connector according to the embodiment taken along the line A-A shown in FIG. 4;

FIG. 8C is a cross-sectional view illustrating the configuration of the shield connector according to the embodiment, with the outer housing removed from the configuration shown in FIG. 8B;

FIG. 8D is a cross-sectional view illustrating the configuration of the shield connector according to the embodiment, with the outer housing removed from the configuration shown in FIG. 8A;

FIG. 9 is an exploded perspective view illustrating the whole components of the shield connector according to the embodiment;

FIG. 10A is a view illustrating the configuration of the shield connector according to the embodiment, showing a metal shell in a perspective view;

FIG. 10B is a view illustrating the configuration of the shield connector according to the embodiment, showing the metal shell seen from the rear side;

FIG. 10C is a view illustrating the configuration of the shield connector according to the embodiment, showing the metal shell seen from the top;

FIG. 10D is a view illustrating the configuration of the shield connector according to the embodiment, showing the shield connector in a perspective view;

FIG. 10E is a view illustrating the configuration of the shield connector according to the embodiment, showing the metal shell and a cover shell joined with a shielded cable in a perspective view;

FIG. 11A is a view illustrating an assembly process of the shield connector according to the embodiment, showing a shielded cable before termination;

FIG. 11B is a view illustrating the assembly process of the shield connector according to the embodiment, showing the shielded cable with an insulation sheath partially removed from the end of the shielded cable;

FIG. 11C is a view illustrating the assembly process of the shield connector according to the embodiment, showing the shielded cable with a ferrule set on the outer periphery of a braided wire before being crimped;

FIG. 11D is a view illustrating the assembly process of the shield connector according to the embodiment, showing the shielded cable with the ferrule crimped to the outer periphery of the braided wire;

FIG. 11E is a view illustrating the assembly process of the shield connector according to the embodiment, showing the shielded cable with the braided wire folded over the outer periphery of the ferrule;

FIG. 11F is a view illustrating the assembly process of the shield connector according to the embodiment, showing the shielded cable with a predetermined length of metal foil covering the outer periphery of a pair of electric wires removed;

FIG. 11G is a view illustrating the assembly process of the shield connector according to the embodiment, showing the shielded cable with an insulation coating removed from the ends of the electric wires;

FIG. 11H is a view illustrating the assembly process of the shield connector according to the embodiment, showing the shielded cable of FIG. 11G seen from the right side;

FIG. 11I is a view illustrating the assembly process of the shield connector according to the embodiment, showing the ferrule before crimping the ferrule seen from the front;

FIG. 11J is a view illustrating the assembly process of the shield connector according to the embodiment, showing the crimped ferrule alone seen from the front; and

FIG. 11K is a view illustrating the assembly process of the shield connector according to the embodiment, showing the ferrule crimped to the electric wires.

### DETAILED DESCRIPTION OF THE INVENTION

An embodiment of the present invention will be described below with reference to the drawings.

### Configuration of Shield Connector

The configuration of a shield connector according to an embodiment of the present invention will be described first.

### (General Configuration)

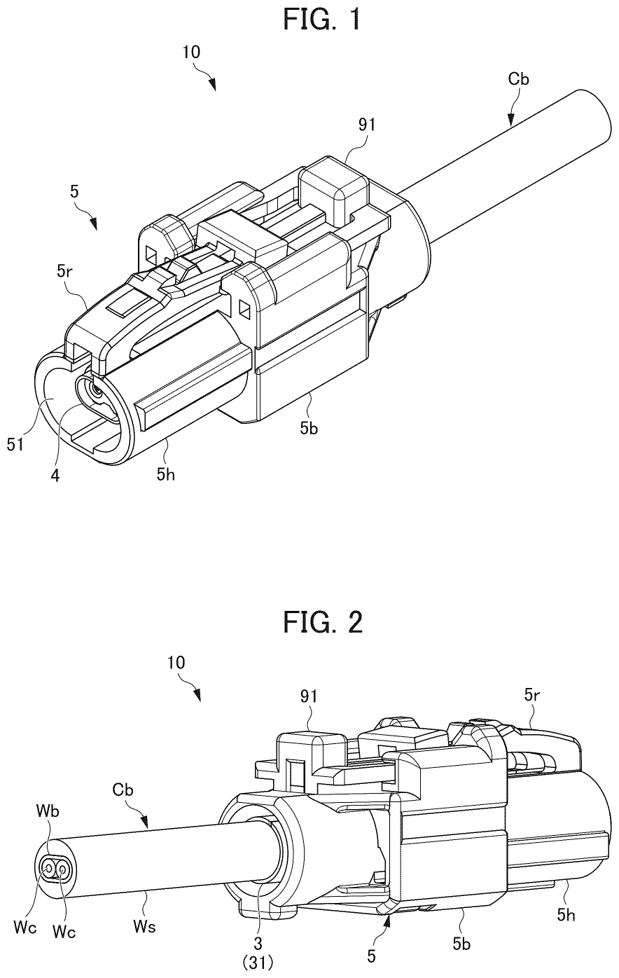

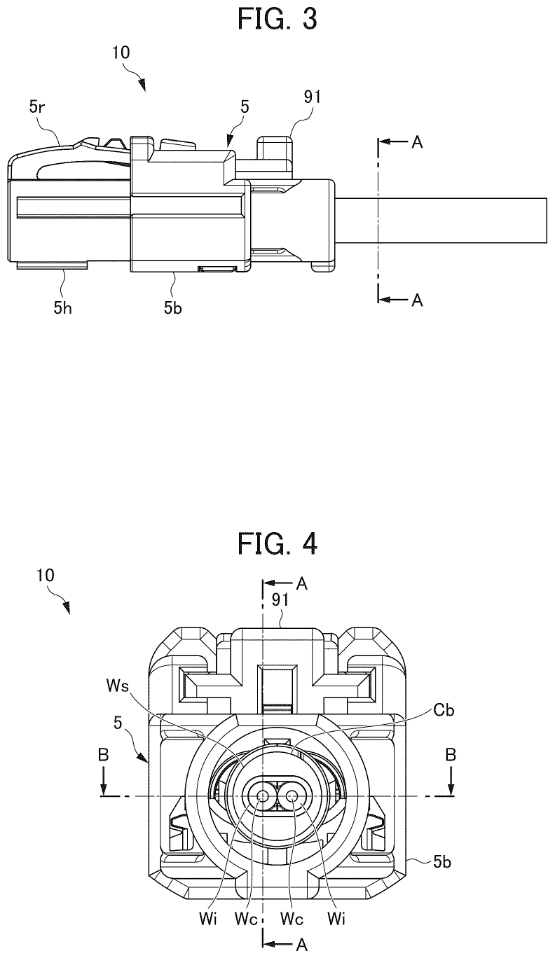

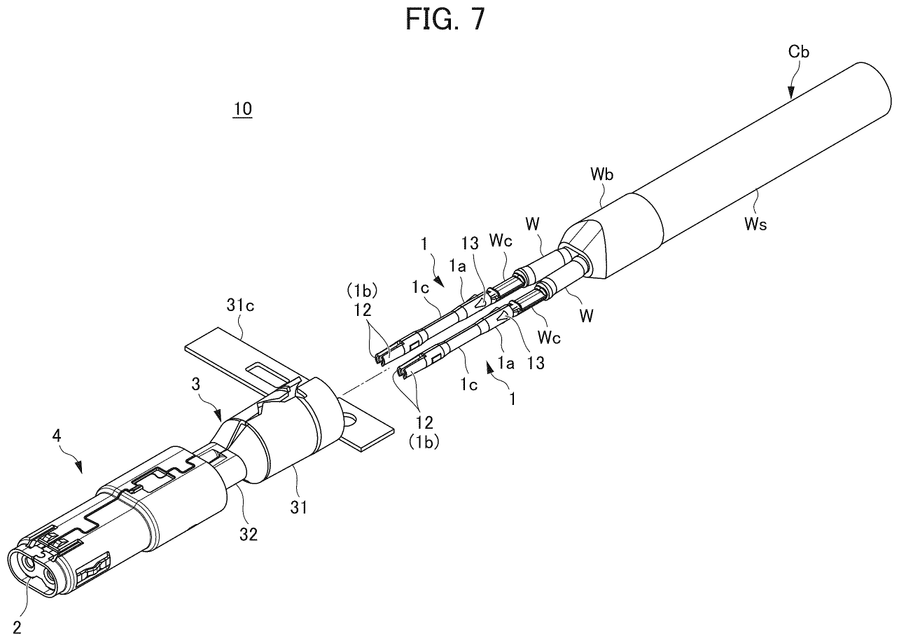

Referring to FIGS. 1 to 7, a shield connector 10 according to the embodiment of the present invention (will be hereinafter abbreviated as a connector) is attachable to an end of a shielded differential cable (will be hereinafter referred to as a shielded cable) Cb. The shielded cable Cb includes a pair of electric wires W, W, a braided wire Wb, and an insulation sheath Ws. Each electric wire W has an insulation-coated core Wc. The braided wire Wb covers the periphery of the pair of electric wires W, W. The insulation sheath Ws covers the braided wire Wb (see FIG. 7 or 9 and FIGS. 11A to 11H).

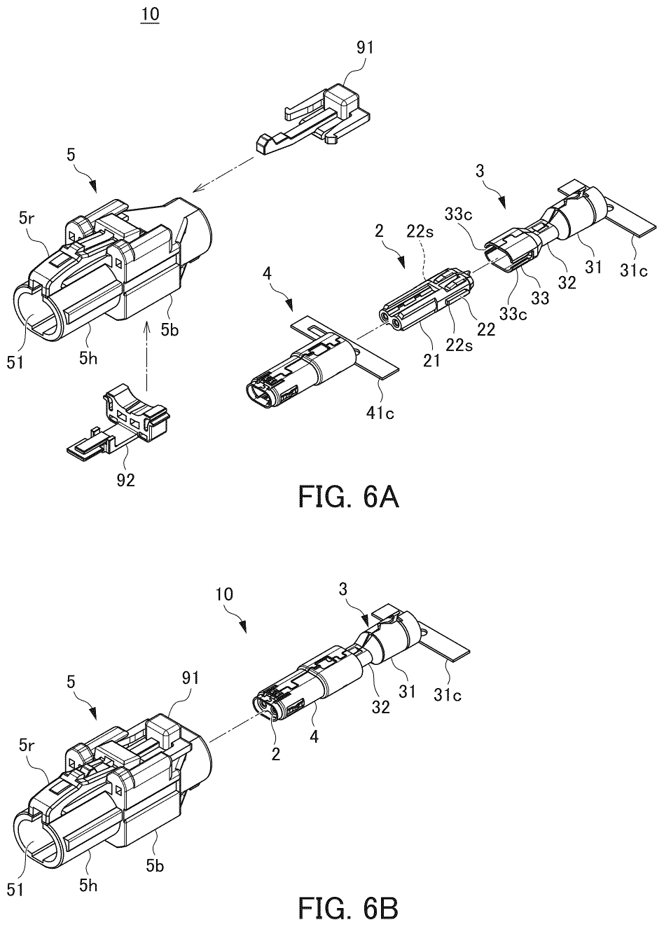

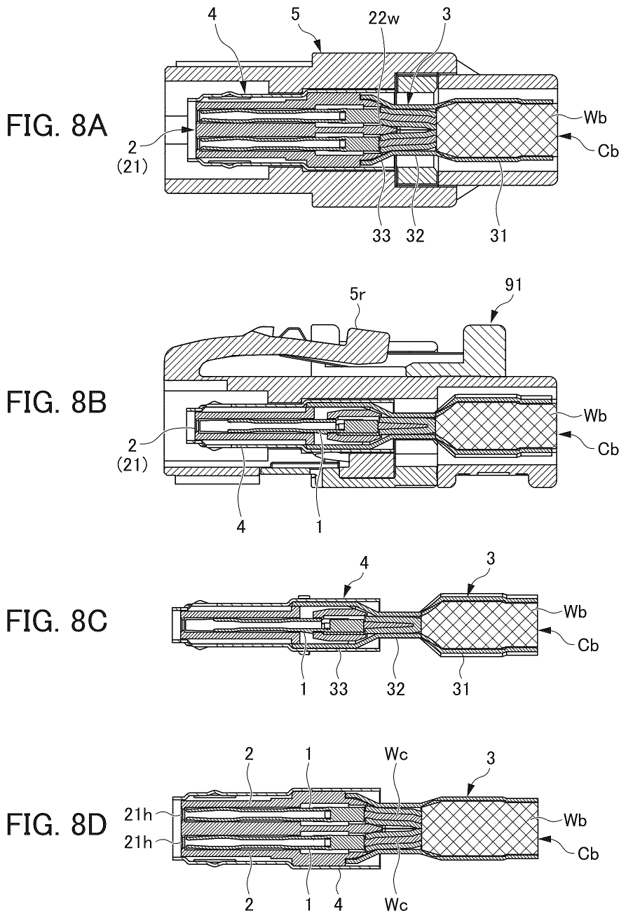

Referring to FIGS. 6A, 6B, 7, and 9, the connector 10 includes a pair of terminals 1, 1 and an elliptic cylinder-shaped inner housing 2. The connector 10 also includes a metal shell 3 and a cover shell 4, both in the shape of an elliptic tube. Each terminal 1 is connected to a corresponding one of the cores Wc (see FIG. 7 or 8D). The inner housing 2 holds the pair of terminals 1, 1 therein (see FIG. 8A or 8B).

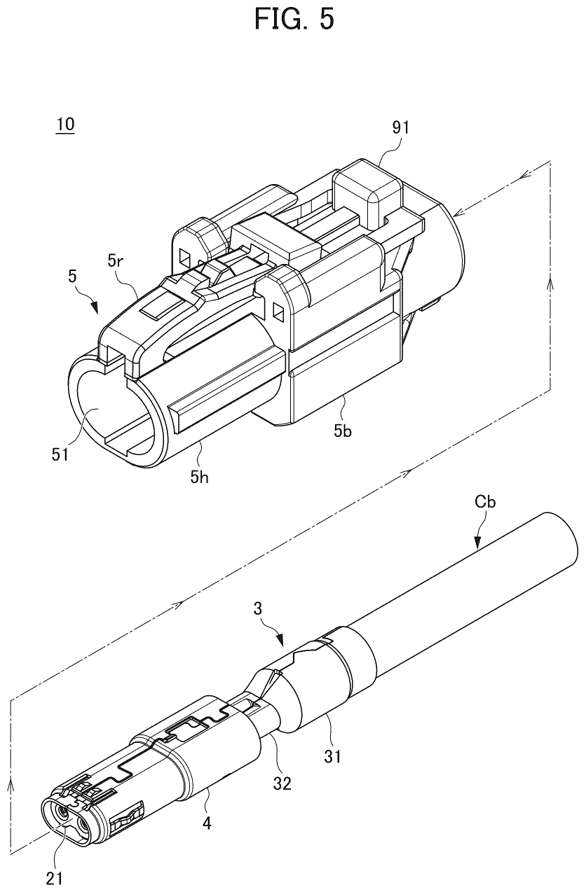

Referring to FIG. 5 or 6B, the cover shell 4 is connected to the metal shell 3 in series. The cover shell 4 covers the inner housing 2 and a front part of the metal shell 3 (see FIG. 8A or 8B).

Referring to FIGS. 8A to 8D, the metal shell 3 is electrically connected to the braided wire Wb. The metal shell 3 covers an exposed part of the pair of electric wires W, W ranging from the end of the braided wire Wb to the terminals 1 to be in close contact with the exposed part. The metal shell 3 includes a crimp portion 31, a terminal hole portion 32, and a connecting portion 33 (see FIG. 7 or FIGS. 8A to 8D). The crimp portion 31, the terminal hole portion 32, and the connecting portion 33 are continuous in an axial direction. Referring to FIG. 8A, the crimp portion 31 is crimped to the braided wire Wb from the outer periphery. Referring to FIG. 8A or 8C, the terminal hole portion 32 allows the exposed part of the pair of electric wires W, W to pass through. Referring to FIG. 8C, the connecting portion 33 covers the inner housing 2 from the outer periphery.

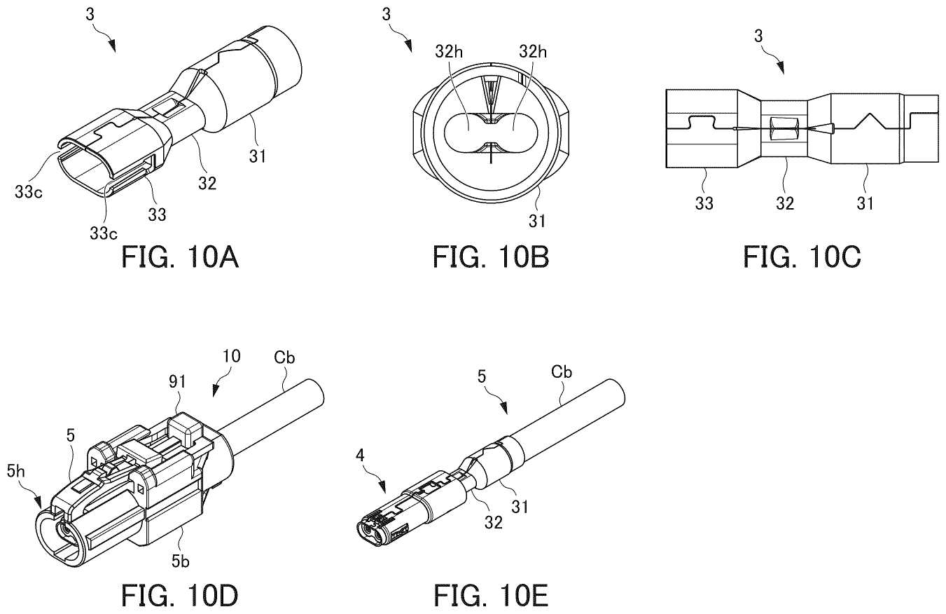

Referring to FIGS. 10A to 10C, the crimp portion 31 is in the shape of an elliptic tube. The terminal hole portion 32 continuous with the crimp portion 31 has a pair of terminal holes 32h, 32h. In the illustrated example, the terminal hole portion 32 is in the shape of an elliptic tube and is thinner than the crimp portion 31. Wall portions of the terminal hole portion 32 facing each other across the major axis are recessed inward at the center to approach each other. This forms the pair of terminal holes 32h, 32h in the terminal hole portion 32. That is, in the illustrated example, the pair of terminal holes 32h, 32h is an inner cavity of the elliptic tube-shaped terminal hole portion 32. The terminal holes 32h, 32h are thinner than the crimp portion 31 and partially connected to each other at an outer edge. Referring to FIG. 8A or 8B, the inner housing 2 has a wedge piece 22w protruding from an end of the inner housing 2. The wedge piece 22w separates the pair of electric wires W, W introduced into the inner housing at a predetermined pitch.

In the shield connector 10 of the embodiment shown in FIGS. 1 to 11H, the inner cavity of the terminal hole portion 32 into which the part of the pair of electric wires W, W exposed from the insulation coating enters is divided to form the terminal holes 32h, 32h that are thinner than the crimp portion 31 and partially connected to each other at an outer edge to be shaped like an “infinity symbol”, allowing the insulation coating Wi on the electric wires W to be in close contact with the inner wall of the terminal holes 32h. This reduces impedance and allows excellent signal transmission in a high frequency band.

In the shield connector 10 shown in FIGS. 6A, 6B, 7, and 8A to 8D, the terminal holes 32h of the terminal hole portion 32 communicate with terminal holes 21h of the inner housing 2, and the inner housing 2 has the wedge piece 22w protruding toward the terminal hole portion 32. The wedge piece 22w separates the pair of electric wires W, W introduced into the inner housing at a predetermined pitch.

### (Configuration of Terminal)

The configuration of the terminals 1 according to the embodiment will be described below. Referring to FIG. 7, each terminal 1 is fixed to the end of the corresponding core Wc. The terminal 1 has a wire connector 1a consisting of a conductor barrel at one end. Crimping the conductor barrel to the core Wc joins the terminal 1 and the electric wire W to be electrically connectable.

Referring to FIG. 7, the terminal 1 has a terminal connector 1b consisting of a pair of clipping pieces 12, 12 at the other end. The terminal connector 1b is formed in the shape of a cylinder having a slit. The terminal connector 1b can function as an open entry that protects the terminal from deformation at the time of insertion of a counterpart terminal.

Referring to FIG. 7, the terminal connector 1b allows a pin-shaped male contact of a counterpart terminal (not shown) to be introduced from a front opening of the terminal connector 1b. Thus, the counterpart terminal which is not shown and the terminal 1 are electrically connected. Although FIG. 7 discloses the terminal 1 as a female terminal, the terminal 1 can be a pin-shaped male terminal.

Referring to FIG. 7, the terminal 1 has one or more triangular pyramid-shaped contact lance 13 protruding from the outer periphery of the wire connector 1a. When the terminal 1 is inserted in the inner housing 2, the contact lance 13 is locked with a housing lance formed on the inner wall of the inner housing 2, keeping the terminal 1 from falling at the time of the insertion of the counterpart terminal.

Referring to FIG. 7, the terminal 1, which is made of a conductive metal plate, can be obtained by forming a developed conductive metal plate into a cylindrical shape. The terminal 1 may be obtained by processing a conductive metal rod into a cylindrical shape.

### (Configuration of Inner Housing)

The configuration of the inner housing 2 according to the embodiment will be described below. Referring to FIGS. 6A, 8A to 8D, and 9, the inner housing 2, which is made of an insulative synthetic resin, can be obtained by molding the insulative synthetic resin into a desired shape.

Referring to FIG. 8D, a pair of terminal holes 21h, 21h is open in a front part 21 of the inner housing 2 (see FIG. 6A). The counterpart terminals which are not shown can be inserted into the terminal holes 21h from the front side. The terminals 1 joined with the electric wires W can be inserted into the terminal holes 21h from a rear part 22.

Referring to FIGS. 8A to 8D, with the terminals 1 housed in the terminal holes 21h, the terminal connectors 1b are located to face the front openings of the terminal holes 21h.

Referring to FIG. 6A, the inner housing 2 has a pair of ribs 22s, 22s protruding in opposing directions from its periphery.

Referring to FIG. 6A, both sides of the connecting portion 33 of the metal shell 3 are cut to form a pair of rectangular notches 33c, 33c that fits with the pair of ribs 22s, 22s. When the rear part 22 of the inner housing 2 is inserted into the metal shell 3, the ribs 22s fit into the notches 33c, determining the position of the inner housing 2 relative to the metal shell 3 in the axial direction of the metal shell 3. This allows the inner housing 2 and the metal shell 3 to be correctly connected in series in the axial direction.

### (Configuration of Metal Shell)

The configuration of the metal shell 3 according to the embodiment will be described below. Referring to FIGS. 5 to 10E, the metal shell 3, which is made of a conductive metal plate, is obtained by forming a developed conductive metal plate into an elliptic tube shape.

Referring to FIGS. 6A, 6B, 7, and 8A to 8D, the metal shell 3 has the crimp portion 31, the terminal hole portion 32, and the connecting portion 33 that are continuous in the axial direction. The crimp portion 31 is formed at a proximal end of the metal shell 3.

Referring to FIGS. 6A, 6B, and 7, a strip-shaped feed plate 31c is provided at a proximal end of the crimp portion 31. After the shielded cables Cb are joined to two or more chained metal shells 3, the metal shells 3 can be separated into individual metal shells 3 each joined with the shielded cable Cb (see FIG. 5) by tearing the feed plate 31c at notches (not shown) connecting the metal shells 3 and the feed plate 31c.

Referring to FIGS. 6A, 6B, 9, and 10C, the terminal hole portion 32 has a smaller outer shape than the crimp portion 31 and the connecting portion 33. Referring to FIG. 5, with the metal shell 3 and the cover shell 4 joined with the shielded cable Cb and assembled with an outer housing 5, a U-shaped second positioning member 92 is inserted into the outer housing 5 from below (see FIG. 6A) to ensure the position of the metal shell 3 relative to the outer housing 5 in the axial direction of the metal shell 3.

### (Configuration of Cover Shell)

The configuration of the cover shell 4 according to the embodiment will be described below. Referring to FIGS. 5 to 7, the cover shell 4, which is made of a conductive metal plate, is obtained by forming a developed conductive metal plate into an elliptic tube shape.

Referring to FIG. 8A or 8B, a proximal end of the cover shell 4 fits with a distal end of the metal shell 3 to be in close contact. The cover shell 4 is connected to the metal shell 3 in series in the axial direction. The cover shell 4 is electrically connected to the metal shell 3 (see FIGS. 6A and 6B).

Referring to FIGS. 8A to 8D, the cover shell 4 covers the inner housing 2 and the front part of the metal shell 3. The cover shell 4 holding the inner housing 2 receives the metal shell 3 inserted therein to fit with the metal shell 3. In this case, the lance protruding from the upper surface of the front part of the metal shell 3 is locked with an opening formed in the upper surface of the cover shell 4, keeping the metal shell 3 from detaching from the cover shell 4.

### (Configuration of Outer Housing)

The configuration of the outer housing 5 according to the embodiment will be described below. Referring to FIGS. 1 to 6B, the outer housing 5 includes a substantially rectangular parallelepiped-shaped body 5b and an elliptic tube-shaped header 5h. The body 5b can house therein the metal shell 3 and the cover shell 4 joined with the shielded cable Cb shown in FIG. 5 (they will be hereinafter referred to as a terminal assembly).

Referring to FIG. 1 or 2, the header 5h protrudes from a front surface of the body 5b. The header 5h has a connector opening 51 which can receive a header of a counterpart connector (see FIG. 1). The header 5h houses the cover shell 4 inside (see FIGS. 1 and 8B).

Referring to FIGS. 1 to 6B, the header 5h has a locking arm 5r on the upper surface. The locking arm 5r can fit with a latch member of a counterpart connector which is not shown.

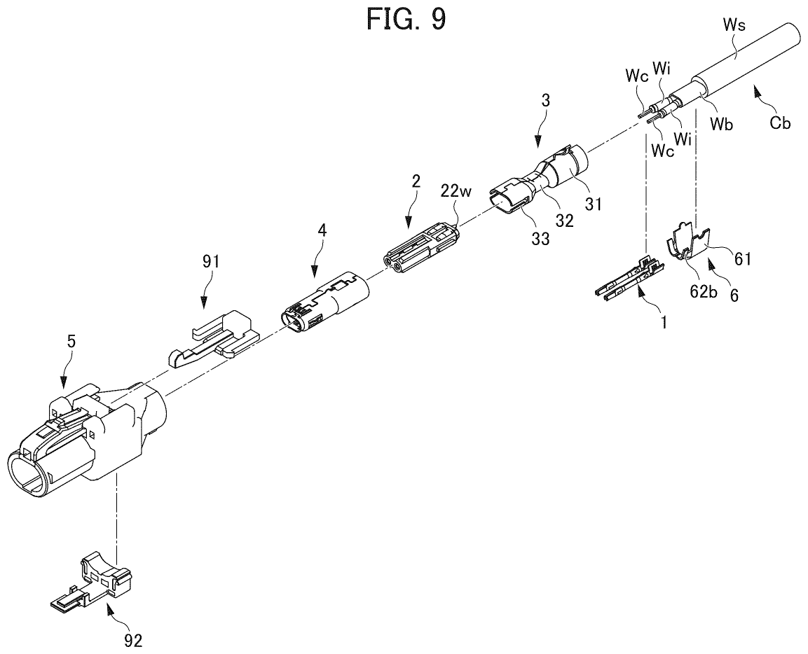

Referring to FIG. 6A or 9, the outer housing 5 has a first positioning member (will be hereinafter referred to as a CPA) 91. With the locking arm 5r locked with the latch member of the counterpart connector, the CPA 91 is inserted into the outer housing 5 from the rear side toward the locking arm 5r and locked with the locking arm 5r, keeping the latch member and the locking arm 5r locked together. This ensures the positioning of the counterpart connector and the outer housing 5.

Referring to FIGS. 1 to 6B, the outer housing 5, which is made of an insulative synthetic resin, can be obtained by molding the insulative synthetic resin into a desired shape having a cavity inside.

Referring to FIG. 6A or 9, the outer housing 5 also includes a rectangular parallelepiped-shaped second positioning member (will be hereinafter referred to as a TPA) 92. The body 5b has a rectangular opening that can receive the TPA 92 at the bottom. The opening communicates with the cavity inside the body 5b.

Referring to FIG. 6A or 9, the terminal assembly is inserted into the outer housing 5 from the rear side (see FIG. 5), and the TPA 92 is inserted into the opening at the bottom of the body 5b from below with the terminal assembly fitted in the outer housing 5. Then, an arc surface of the TPA 92 (see FIG. 6A) makes contact with the terminal hole portion 32 of the metal shell 3 (see FIG. 9). Specifically, the opening is formed at an axial position where the TPA 92 makes contact with the terminal hole portion 32.

Referring to FIG. 6A or 9, the terminal hole portion 32 is narrower than the crimp portion 31 and the connecting portion 33. Thus, when the TPA 92 is attached to the outer housing 5, the TPA 92 can restrict the axial movement of the metal shell 3 relative to the outer housing 5 (see FIG. 8B).

### (Assembly of Shield Connector)

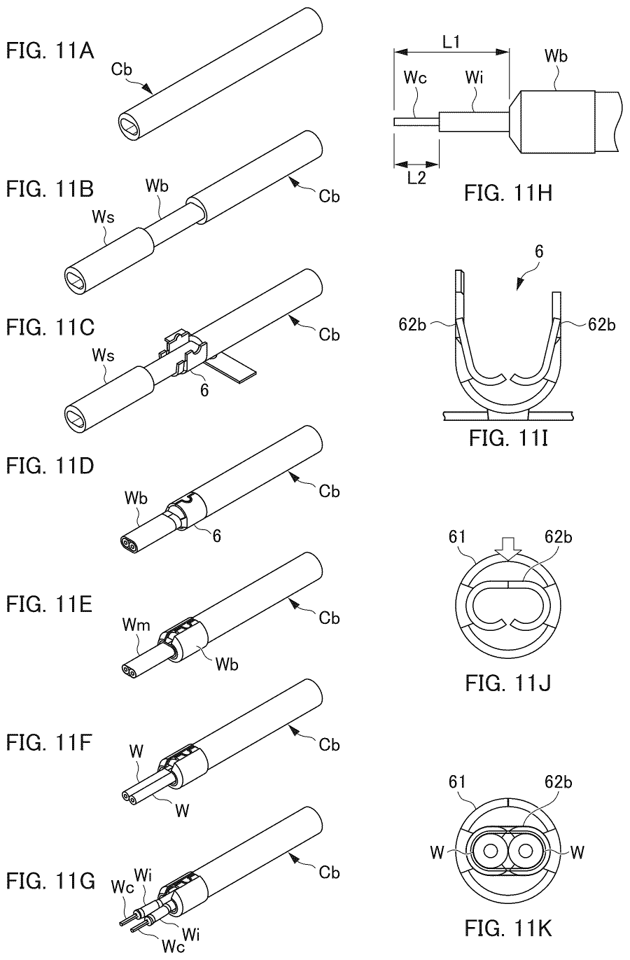

How the connector 10 according to the embodiment is assembled will be described below. First, the shielded cable Cb is terminated as shown in FIGS. 11A to 11K.

The insulation sheath Ws alone is peeled off the unterminated shielded cable Cb shown in FIG. 11A while leaving a predetermined length from the end face of the shielded cable Cb (see FIG. 11B). Then, the ferrule 6 in an open state is set on the braided wire Wb (see FIG. 11C) exposed on the shielded cable Cb partially stripped as shown in FIG. 11B. Referring to FIGS. 11I to 11K, the ferrule 6 has a first crimp portion 61 and a pair of second crimp portions 62b, 62b. The ferrule 6 is then crimped onto the braided wire Wb (see FIG. 11D). The ferrule 6, which is in the shape of a U-shaped open crimp barrel as shown in FIG. 11I, is bent to be crimped onto the braided wire Wb. Referring to FIG. 11J, once the ferrule 6 is bent, the second crimp portions 62b, 62b are reduced in diameter in a direction from the first crimp portion 61 to the second crimp portions 62b, 62b, with their outer edges partially connected to and continuous with the first crimp portion 61. Referring to FIG. 11K, the pair of second crimp portions 62b, 62b is crimped to the braided wire Wb from the outer periphery. Referring to FIG. 11D, the first crimp portion 61 is bent into a cylindrical shape with an air layer left between the first crimp portion 61 and the braided wire Wb. After the crimping, an end of the braided wire Wb is folded over the ferrule 6 (see FIG. 11E). Crimping the braided wire Wb folded over the ferrule 6 with the crimp portion 31 sandwiches the braided wire Wb between the ferrule 6 and the metal shell 3. This allows conduction between the metal shell 3 and the braided wire Wb.

Then, metal foil Wm covering the electric wires W shown in FIG. 11E is removed from the ends of the electric wires W (see FIG. 11F). Then, the insulation coating Wi is removed from the ends of the electric wires W shown in FIG. 11F (see FIG. 11G). Thus, the termination of the shielded cable Cb finishes. As shown in FIG. 11H, the electric wires W are exposed from the end of the shielded cable Cb by a length “L1”, and the cores Wc are exposed from the ends of the electric wires W by a length “L2”.

Then, referring to FIG. 11G, the cores Wc exposed at the ends of the electric wires W are inserted into the wire connectors 1a of the terminals 1. Crimping the wire connectors 1a can fix the terminals 1 at the ends of the electric wires W (see FIG. 7).

Referring to FIG. 7, the electric wires W joined with the pair of terminals 1, 1 are inserted into the terminal holes 32h of the metal shell 3 from the rear side of the metal shell 3. With each electric wire W passing through the terminal hole 32h, a truncated cone-shaped part (the braided wire Wb folded over the ferrule 6) abuts on the wall at the end of the crimp portion 31 to stop the shielded cable Cb relative to the metal shell 3. At this time, the insulation coating Wi on each electric wire W enters the terminal hole portion 32 and makes close contact with the inner wall of the terminal hole 32h.

The electric wires W joined with the pair of terminals 1, 1 pass through the terminal holes 32h and enter the terminal holes 21h of the inner housing 2 arranged inside the cover shell 4. In this state, the wedge piece 22w protruding toward the front part of the metal shell 3 separates the ends of the electric wires W, W at a predetermined pitch. Referring to FIG. 7, each terminal 1 has the contact lance 13 that protrudes from the periphery of the wire connector 1a and is locked with a stepped portion formed on the inner wall of the inner housing 2. This keeps the shielded cable Cb from falling off the inner housing 2.

The braided wire Wb is covered with the insulation sheath Ws, the inner housing 2, and the metal shell 3 between the end of the shielded cable Cb and the pair of terminals 1, 1. Thus, the cores Wc are not exposed to the outside. The metal shell 3 and the cover shell 4 joined with the shielded cable Cb shown in FIG. 5 function as the shield connector, or the terminal assembly. When the terminal assembly is mounted on the outer housing 5, the terminal assembly functions as a harness that allows easy connection with the counterpart connector.

The terminal assembly completed in this manner is inserted into the outer housing 5 from the rear side of the outer housing 5 (see FIGS. 6A and 6B). Then, as shown in FIG. 8B, with the terminal assembly fixed inside the outer housing 5, the TPA 92 is inserted into the outer housing 5 from below the outer housing 5 (see FIG. 6A or 9). The TPA 92 fitted in the outer housing 5 can restrict the axial movement of the metal shell 3 relative to the outer housing 5.

When the CPA 91 is attached to the outer housing 5 with the locking arm 5r locked with the latch member of the counterpart connector, the latch member and the locking arm 5r can be kept locked together.

### Advantages of Shield Connector

The advantages of the connector 10 according to the embodiment will be described below.

The connector 10 of the embodiment includes a pair of terminals 1, 1 each connected to a corresponding one of the cores Wc, the inner housing 2 holding the pair of terminals 1, 1 therein, the metal shell 3 that covers an exposed part of the pair of electric wires W, W to be in close contact with the exposed part, and the cover shell 4 connected to the metal shell 3 in series. An inner cavity of the terminal hole portion 32 into which part of the electric wires W exposed from an insulation coating enters is divided to form a pair of terminal holes 32h, 32h that are thinner than the crimp portion 31 and partially connected to each other at an outer edge to be shaped like an “infinity symbol”, allowing the insulation coating Wi on the electric wires W to be in close contact with the inner wall of the terminal holes 32h. This reduces impedance and achieves excellent signal transmission in a high frequency band.

Referring to FIGS. 5 to 11H, the connector 10 according to the embodiment allows easy insertion of the electric wires W with the terminals 1 at the tip ends into the terminal holes 32h, and the inner housing 2 has the wedge piece 22w protruding from the end of the inner housing 2. Thus, the ends of the pair of electric wires W, W in close contact can be separated from each other at a predetermined pitch.

Referring to FIGS. 1 to 6B, the connector 10 according to the embodiment has the CPA 91 (the first positioning member) that keeps the latch member and the locking arm 5r locked together, ensuring the positioning of the counterpart connector and the outer housing 5.

Referring to FIG. 6A or 9, the connector 10 according to the embodiment has the TPA 92 (the second positioning member) that is inserted into the outer housing 5 from below toward the terminal hole portion 32, restricting the axial movement of the metal shell 3 relative to the outer housing 5.

The disclosed embodiment of the shield connector of the present invention is attached to an end of a two-pole shielded cable having a pair of electric wires covered with a braided wire. However, the shield connector of the present invention is also attachable to, for example, an end of a multipole shielded cable having a pair of electric wires covered with a braided wire.

### EXPLANATION OF REFERENCE NUMERALS

1 Terminal
2 Inner housing
3 Metal shell
4 Cover shell
10 Connector (shield connector)
21h Terminal hole
22w Wedge piece
31 Crimp portion
32 Terminal hole portion
Cb Shielded cable (shielded differential cable)
W Electric wire
Wc Core
Wb Braided wire
Ws Insulation sheath

What is claimed is:

1. A shield connector attachable to an end of a shielded differential cable including a pair of electric wires each having an insulation-coated core, a braided wire covering the electric wires, and an insulation sheath covering the braided wire, the shield connector comprising:
a pair of terminals each connected to a corresponding one of the cores;
an inner housing holding the pair of terminals therein;
an elliptic tube-shaped metal shell that is electrically connected to the braided wire and covers an exposed part of the pair of electric wires ranging from an end of the braided wire to the terminals to be in close contact with the exposed part; and
an elliptic tube-shaped cover shell that is connected to the metal shell in series and covers the inner housing and a front part of the metal shell, wherein
the metal shell includes
a crimp portion that is crimped to the braided wire from an outer periphery,
a terminal hole portion through which the exposed part of the electric wires passes; and
a connecting portion that covers the inner housing from an outer periphery,
the terminal hole portion includes a pair of terminal holes that are thinner than the crimp portion and partially connected to each other at an outer edge, and
the inner housing has a wedge piece that protrudes from an end of the inner housing and separates ends of the pair of electric wires at a predetermined pitch.

2. The shield connector according to claim 1, wherein each terminal includes
a wire connector formed at one end and having a conductor barrel connected to the core by crimping and
a terminal connector formed at the other end and having a pair of clipping pieces connectable to a counterpart connector.

3. The shield connector according to claim 1, further comprising an outer housing holding therein the metal shell connected to the shielded differential cable.

4. The shield connector according to claim 3, wherein the outer housing includes a second positioning member that is inserted into the outer housing from below toward the terminal hole portion and restricts an axial movement of the metal shell relative to the outer housing.
